(19) United States
(12) Patent Application Publication
(10) Pub. No.: US 2018/0146648 A1
(43) Pub. Date: May 31, 2018

(54) Fish Stringer

(71) Applicant: Ryan Dorris, Magnolia, TX (US)

(72) Inventor: Ryan Dorris, Magnolia, TX (US)

(21) Appl. No.: 15/882,215

(22) Filed: Jan. 29, 2018

(51) Int. Cl. A01K 65/00; A22C 25/10

(52) U.S. Cl. CPC A01K 65/00; A22C 25/10

(57) ABSTRACT

A fish stringer is constructed so that a clamp for attachment to the belt of the fisherman can also be used as the stringer that passes through the gills of the fish. A tether is attached at one end to the clamp and the other end of the tether may be attached to a suitable support which may include the clamp itself, a support structure, or a flotation device.

### BACKGROUND OF INVENTION

### 1. Field of the Invention

This application is directed to a fish stringer for use by fishermen to temporarily keep recently caught fish alive in the water.

### 2. Description of Related Art

Certain fish stringers generally include an elongated needle, a tether attached to the needle and a clip for securing the needle to the belt of the fisherman. The tether may also be attached to the clip or another support number. For example, in U.S. Pat. No. 5,301,859, a fish stringer includes a needle, a tether 4 and a belt mounted clip 72 for securing the needle 6. Additionally U.S. Pat. No. 5,025,587 discloses a needle 16, a tether 14 and a belt mounted clip 12. In both instances the stringer requires a needle member and a separate clip.

### BRIEF SUMMARY OF THE INVENTION

The requirement for a separate clip and needle is eliminated according to an embodiment of the invention. The needle is formed as an elongated clamp that is adapted to be inserted through the gills of a fish an also adapted to be releasably attached to the belt of the fisherman.

### BRIEF DESCRIPTION OF THE DRAWING(S)

FIG. 1 is a side view of a stringer clamp according to an embodiment of the invention.

FIG. 2 is an exploded view of the stringer clamp of FIG. 1.

FIG. 3 is a cross-sectional view taken along line 3-3 of FIG. 1.

FIG. 4 is a view an elevation view of the use of the stringer according to an embodiment of the invention

Although the present invention will be described with respect to specific details, it is not intended that such details should be regarded as limitations on the scope of the invention, except to the extent that they are included in the accompanying claims.

### DETAILED DESCRIPTION OF THE INVENTION

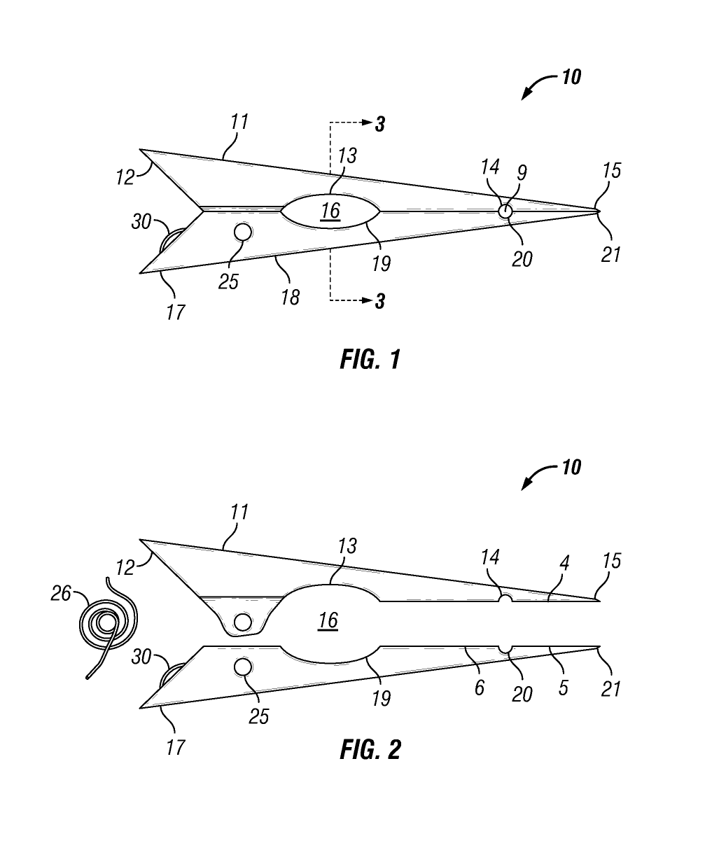

As shown in FIGS. 1 and 2, an embodiment of the invention includes a clamp 10 which includes two members 12 and 17 that are pivotally attached to each at a pivot point 25. The two members are biased to the closed position of FIG. 1 by a coil spring 26.

Flat surfaces 3, 4, 6, and 7 are in contact with each other. The operation of clamp 10 is similar to that of an alligator clip, with coil spring encircling a pivot shaft that extends between pivot points 25.

Coil spring has two ends, one of which engages member 12 while the other engages member 17.

A first opening 16 for receiving the belt of a user is formed by cutouts 13, 19 formed in members 12, 17 as shown in FIG. 2. A second opening 9 extends through the clamp and is formed by grooves 14 and 20 in members 12, 17. Member 17 may include a loop 30 for attaching the tether to the clamp.

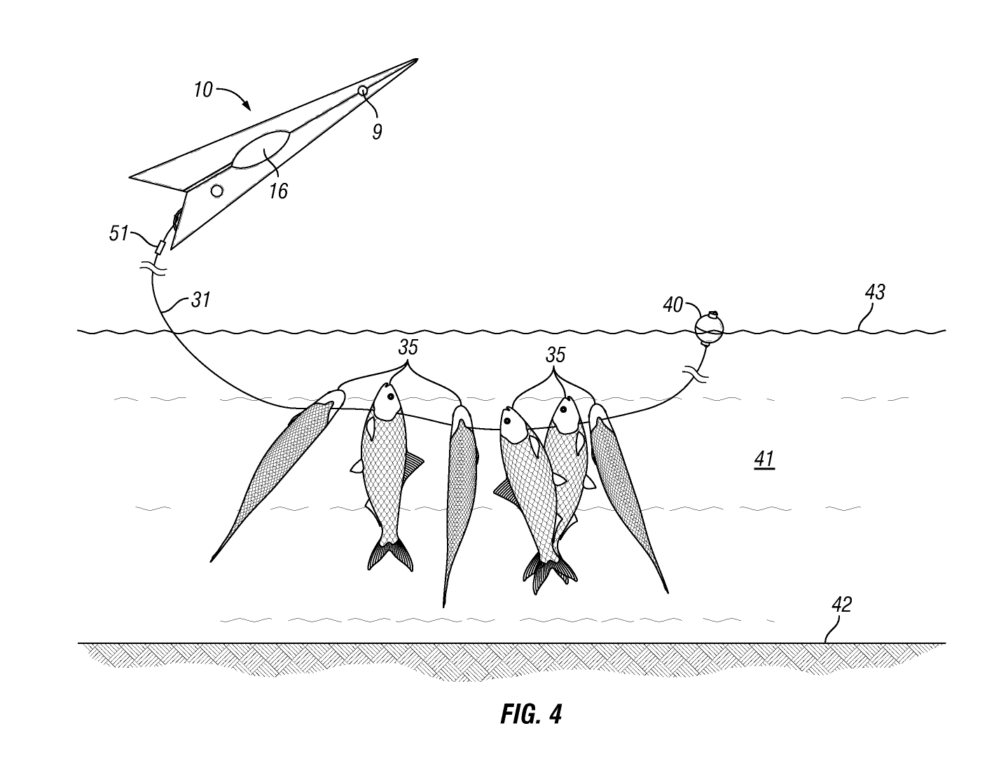

Members 12 and 17 terminate in needle like tips 15, 21 that are adapted to facilitate insertion of clamp 10 through the gills of the fish 35 as shown in FIG. 4. Also, as shown in FIG. 4, one end of the tether 31 can be connected to the clamp 10 while the other end may be connected to a flotation device 40 on the surface 43 so that fish are positioned within the body of water 41 above the floor 42.

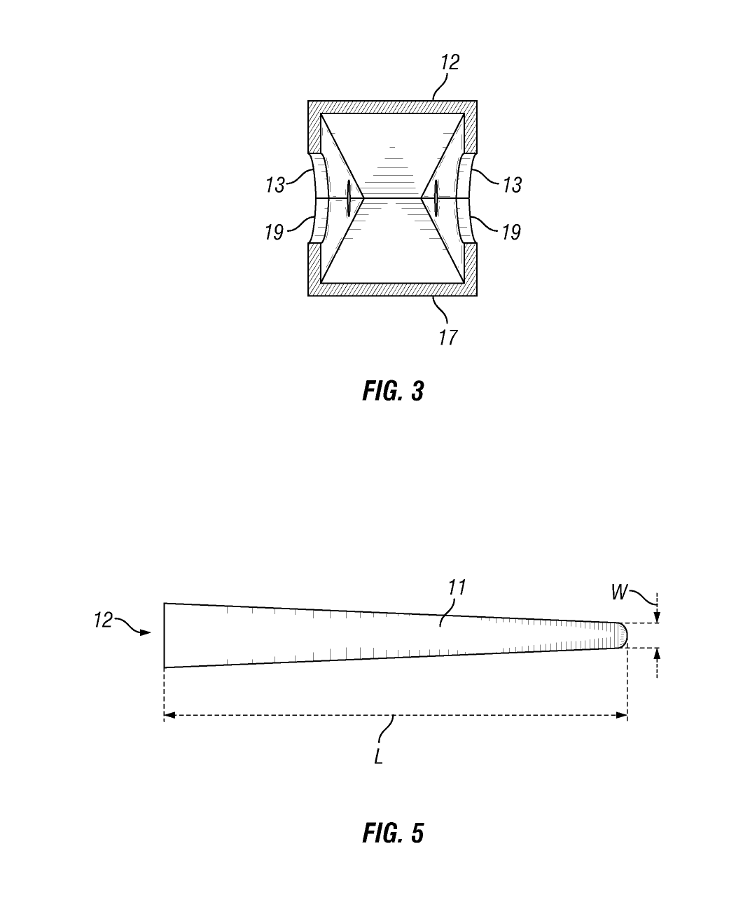

As shown in FIG. 3, members 12 and 17 may be u-shaped in cross section, and sized so that member 12 can fit within member 17 at the pivot point 25. As shown in FIG. 5 member 11 is shaped so as to taper to a tip 15. Lower member 17 is similarly shaped to end in a tip portion 21. As shown in FIG. 5, clamps 10 has a length that is considerably greater than the width. For example the length of the clamp may range between 2-8 inches whereas the width at the tip may be about one eight to one quarter inch and may be rounded.

A safety breakaway connection 51 may be provided in the tether in the event that a substantial force is put on the tether.

It should be recognized that these are many equivalent ways to construct the clamp of the present invention and one embodiment has been described herein.

I claim:

1. A fish stringer comprising:
a) a clamp including two members pivotably connected to each other and having a transversely extending internal opening for receiving a belt of a user, the clamp having a nose portion suitable for passing through the gills of fish,
b) a tether adapted to be connected at a first end to the clamp, the tether being connected at a second end to a flotation device, a structural member, or to another portion of the clamp.

2. The fish stringer as claimed in claim 1 wherein the two members are biased to a closed position.

3. The fish stringer as claimed in claim 1 further including a second opening extending through the clamp for receiving a tethering device fixed to the clamp.

4. The fish stringer as claimed in claim 1 wherein the two members are u-shaped in cross section and are sized to fit one within the other at a pivot connection.
